(19) United States
(12) Patent Application Publication
(10) Pub. No.: US 2016/0162083 A1
(43) Pub. Date: Jun. 9, 2016

(54) TOUCH DISPLAY PANEL AND TOUCH DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventor: Dayu ZHANG, Beijing (CN)

(73) Assignees: BOE TECHNOLOGY GROUP CO., LTD., Beijing (CN); HEFEI XINSHENG OPTOELECTRONICS TECHNOLOGY CO., LTD., Hefei (CN)

(21) Appl. No.: 14/738,990

(22) Filed: Jun. 15, 2015

(30) Foreign Application Priority Data
Dec. 5, 2014 (CN) 201410735371.4

(51) Int. Cl. G06F 3/041

(52) U.S. Cl. CPC G06F 3/0412

(57) ABSTRACT

A touch display panel, including a touch display panel body, a control board and a display circuit connection board, wherein the a display driving circuit which drives the touch display panel body to display is arranged on the control board and electrically connected to the control board; the display circuit connection board is electrically connected to the control board and the touch display panel body, respectively; the touch display panel further includes a touch circuit connection board, wherein the touch circuit connection board is electrically connected to the control board and the touch display panel body; a touch driving circuit which drives the touch display panel body to touch is arranged one the control board and electrically connected to the control board.

### CROSS-REFERENCE TO RELATED APPLICATION

This application claims a priority to Chinese Patent Application No. 201410735371.4 filed on Dec. 5, 2014, the disclosure of which is incorporated in its entirety by reference herein.

### TECHNICAL FIELD

The present disclosure relates to the field of touch display technology, in particular to a touch display panel and a touch display device.

### BACKGROUND

Currently, taking a note book (NB) as an example, a control circuit of a touch display device mainly includes an Edge to Panel (ETP) structure and an Edge to Edge (ETE) structure.

The Edge to Panel in the ETP structure refers that one control board is located at an edge side of the touch display panel. Specifically, as shown in FIG. 1, in the ETP structure, a touch driving circuit 41 is directly formed at a Flexible Printed Circuit (FPC) board. A touch line and a sensing line are directly bonded to a touch driving electrode (Tx) and a touch sensing electrode (Rx) through the FPC board, respectively, so that the touch driving circuit may receive touch signals emitted from the touch driving electrode Tx and the touch sensing electrode Rx. For such structure, the touch line and the sensing line of the touch driving circuit may be directly arranged at the FPC board, so that connectors for connecting the FPC board and the touch line/the sensing line are eliminated.

The Edge to Edge in the ETE structure refers that two different control boards are located at two opposite edge sides of the touch display panel, respectively. Specifically, as shown in FIG. 2, in the ETE structure, a display driving circuit 31 is formed at one control board 20, a touch driving circuit 41 is formed at the other control board 20, a touch line and a sensing line are directly bonded to a touch driving electrode (Tx) and a touch sensing electrode (Rx) through a touch circuit connection board 40, eg. FPC board, respectively. The touch driving circuit 41 is electrically connected to the touch circuit connection board 40 through a touch circuit connector 42, so as to allow the touch driving circuit to receive signals emitted from the touch driving electrode Tx and touch sensing electrode Rx, respectively. For such structure, the touch driving circuit 41 is directly formed at the control board 20, so that difficulties of performing Surface Mount Technology (SMT) on the touch driving circuit may be reduced, and a defect rate of SMT is also decreased.

However, in the ETP structure, as the touch driving circuit is directly formed at the FPC which has a high cost, it may increase the overall cost and difficulties of performing SMT on the touch driving circuit, thereby to increase the defect rate of SMT.

In the ETE structure, as the touch driving circuit is formed at an extra control board, additional touch circuit connectors are required, so that cost of Bill of Materials (BOM) of products is significantly increased.

Therefore, it is one of the most urgent problems to provide a touch display panel which may improve the yield when performing SMT on the touch driving circuit process and reduce the cost of materials.

### SUMMARY

An object of the present disclosure is to provide a touch display panel and a touch display device, so as to improve the yield when performing Surface Mount Technology (SMT) process on a touch driving circuit and reduce cost of materials, thereby to further increase product profits.

In one aspect, the present disclosure provides in an embodiment a touch display panel, including a touch display panel body, a control board and a display circuit connection board,
wherein a display driving circuit which drives the touch display panel body to display is arranged on the control board and electrically connected to the control board;
the display circuit connection board is electrically connected to the control board and the touch display panel body, respectively;
the touch display panel further includes a touch circuit connection board,
wherein the touch circuit connection board is electrically connected to the control board and the touch display panel body,
a touch driving circuit which drives the touch display panel body to touch is arranged on the control board and electrically connected to the control board.

Alternatively, a touch circuit connector which connects the touch circuit connection board and the control board is arranged on the control board.

Alternatively, the touch display panel body includes a touch driving electrode and a touch sensing electrode which are insulated from each other; and
the touch circuit connection board is electrically connected to the touch driving electrode and the touch sensing electrode through a touch connection line and a sensing connection line, respectively.

Alternatively, a system connector is arranged on the control board, the system connector is configured to electrically connect the control board and a system circuit connection board.

Alternatively, the control board is made by a printed circuit board.

Alternatively, the display circuit connection board is made by a flexible printed circuit board.

Alternatively, wherein the touch circuit connection board is made by a flexible printed circuit board.

In another aspect, the present disclosure provides in embodiments a touch display device, including the above-mentioned touch display panel.

Alternatively, the touch display device further includes a keyboard device.

Alternatively, a system connector is arranged on the control board of the touch display panel;
a system circuit board, configure to control the control board, is arranged inside the keyboard device; and
the system circuit board is electrically connected to the control board through the system connector.

According to embodiments of the present disclosure, for the above-mentioned touch display panel, the display driving circuit which is electrically connected to the touch display panel body through the display circuit connection board, is arranged at one same control board with the touch driving circuit which is electrically connected to the touch display panel body through the touch circuit connection board, so as to improves the yield when performing Surface Mount Technology (SMT) on the above two circuits which may achieve touch and display functions, and prevent cost of the Bill of Material (BOM) from increasing due to an extra structure such as the control board, thereby to further increase profits of the touch display product.

### BRIEF DESCRIPTION OF THE DRAWINGS

In order to illustrate embodiments of the present disclosure and the technical solution in the prior art more clearly, drawings required therein will be described briefly hereinafter. Apparently, drawings described below are merely some examples of the present disclosure, it would be appreciated that a person skilled in the art may also obtain other drawings in accordance with these drawings without creative effort.

FIG. 1 is a schematic view showing a touch display panel having an edge to panel (ETP) structure in the related art;

FIG. 2 is a schematic view showing a touch display panel having an edge to edge (ETE) structure in the related art;

FIG. 3 is a schematic view showing a touch display panel according to an embodiment of the present disclosure;

FIG. 4 is a schematic view showing a touch display device according to an embodiment of the present disclosure; and

FIG. 5 is a schematic view showing a touch display device according to another embodiment of the present disclosure.

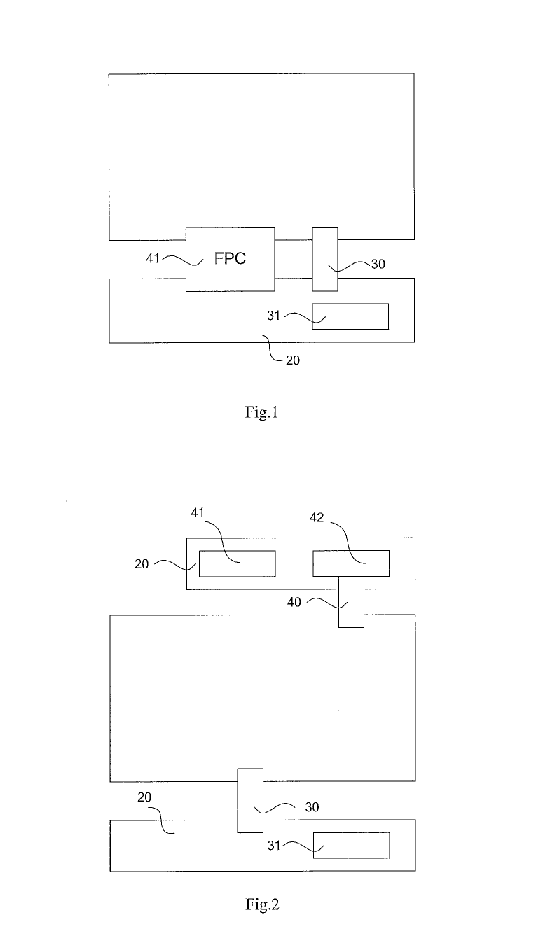

### DETAILED DESCRIPTION

The technical solutions and the advantages of the present disclosure more apparent, the present disclosure will be described hereinafter in a clear and complete manner in conjunction with the drawings and embodiments. Apparently, the following embodiments are merely a part of, rather than all of, the embodiments of the present disclosure, and based on these embodiments, a person skilled in the art may obtain the other embodiments, which also fall within the scope of the present disclosure.

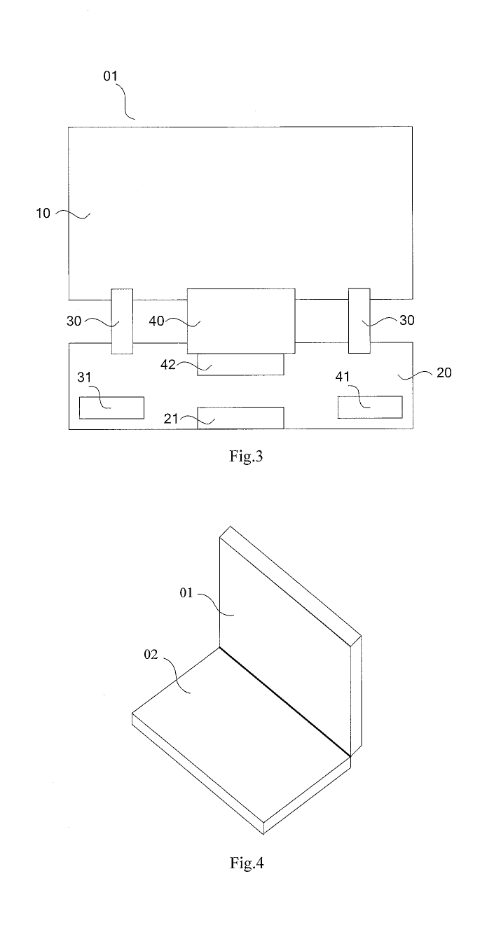

The present disclosure provides in embodiments a touch display panel 01, as shown in FIG. 3, the touch display panel 01 includes: a touch display panel body 10, a control board 20, a display circuit connection board 30, wherein a display driving circuit 31, configured to drive the touch display panel body 10 to display, is arranged on the control board 20 and electrically connected to the control board 20; the display circuit connection board 30 is electrically connected to the control board 20 and the touch display panel body 10, respectively; the touch display panel 01 further includes a touch circuit connection board 40; the touch circuit connection board 40 is electrically connected to the control board 20 and the touch display panel body 10, respectively; and a touch driving circuit 41, configured to drive the touch display panel body 10 to touch, is arranged on the control board 20 and electrically connected to the control board 20.

It should note that the touch display panel body 10 may be, for example, a Touch On Cell type, i.e., attaching a touch panel formed with a touch driving electrode (Tx) and a touch sensing electrode (Rx) to a display side of a display panel; or the touch display panel body 10 may also be a Touch In Cell type, i.e., the touch driving electrode (Tx) and the touch sensing electrode (Rx) are formed at an internal side of the display panel, for example, formed at a color filter substrate of a liquid display panel, or formed at a cover plate of an organic electroluminescence display panel, which is not limited herein by embodiments of the present disclosure.

Further, in the above-mentioned touch display panel 01 according to embodiments of the present disclosure, the display circuit connection board 30 and/or the touch circuit connection board 40 are/is connected to the control board 20 in a manner, including but not limited to, for example, thermo-compression, glue mounting (eg., conductive silver adhesives), or electrically connecting by a connector (eg., a connecting terminal).

Herein, the display circuit connection board 30 and/or the touch circuit connection board 40 may be but not limited to, for example, Chip On Film (COF), Tape Automatic Bonding (TAB), Flexible Printed Circuit (FPC), or Printed Circuit Board (PCB).

Besides, there may be two display circuit connection boards 30 as shown in FIG. 3, but not limited to two, the two display circuit connection boards may be distributed at both sides of the touch circuit connection board 40, or may be arranged at one side of the touch circuit connection board 40, which is not specifically limited herein.

Based on the above, in the touch display panel 01 according to embodiments of the present disclosure, as the display driving circuit 31 which is electrically connected to the touch display panel body 10 through the display circuit connection board 30, is arranged at one same control board 20 with the touch driving circuit 41 which is electrically connected to the touch display panel body 10 through the touch circuit connection board 40, so as to improves the yield when performing Surface Mount Technology (SMT) on the above two circuits which may achieve touch and display functions, and prevent cost of the Bill of Material (BOM) from increasing due to an extra structure such as the control board, thereby to further increase profits of the touch display product.

Further, as shown in FIG. 3, a touch circuit connector 42, which connects the touch circuit connection board 40 and the control board 20, is arranged at the control board 20.

Further, the touch display panel body 10 includes a touch driving electrode Tx and a touch sensing electrode Rx which are insulated from each other; the touch circuit connection board 40 is electrically connected to the touch driving electrode and the touch sensing electrode through a touch connection line and a sensing connection line, respectively.

Herein, in order to simplify the manufacture process of the touch circuit, the touch connection line and the sensing connection line may be directly formed at the touch circuit connection board 40, and connected with the touch driving electrode, the touch sensing electrode together through a bonding process, so as to achieve an electrical connection of relative structures.

Further, as shown in FIG. 3, a system connector 21, configured to electrically connect the control board 20 and a system circuit board, is also arranged at the control board.

Specifically, the system connector 21 may include, for example, a connection terminal and a connection line leaded out from the connection terminal, wherein the other end of the connection line is connected to the system circuit board.

Herein, the system circuit panel includes a plurality of components for controlling the touch display panel 01, for example, a central processing unit (CPU), a main memory, a buffer, and other controlling and connecting components. The system circuit panel may output a corresponding image signal to the control board 20, the display circuit connection board 30 drives the touch display panel body 10 to display the corresponding image through the display driving circuit 31 which is electrically connected to the control board 20. In addition, the system circuit board may also receive a corresponding touch signal (eg., position coordinates of a touch point) transmitted by the touch driving electrode 41, and control the touch display panel body 10 to make a corresponding control and achieve an image display function through the touch circuit connection board 40

Base on the above, as a plurality of circuit structures are integrated on the control board 20, then optionally the control board 20 is made by a printed circuit board (PCB) which is easy to form a circuit.

Besides, as the display circuit connection board 30 is required to be connected to a gate driving circuit, a source driving circuit or other circuits in the touch display panel body 10, while the above driving circuits are generally located inside the touch display panel body 10, with the limitation by overall space of the touch display panel, the circuit panel usually requires a certain flexibility during connecting, as a result, the display circuit connection board 30 may be made by a flexible printed circuit (FPC).

Similarly, the touch driving electrode Tx and the touch sensing electrode Rx are also generally located inside the touch display panel body 10, with the limitation by overall space of the touch display panel, the touch circuit connection board 40 may be bended when connecting to Tx and Rx, as a result, the touch circuit connection board 40 may be made by a flexible printed circuit (FPC) having flexibility.

Further, the present disclosure further provides in embodiments a touch display device, including the above-mentioned touch display panel 01.

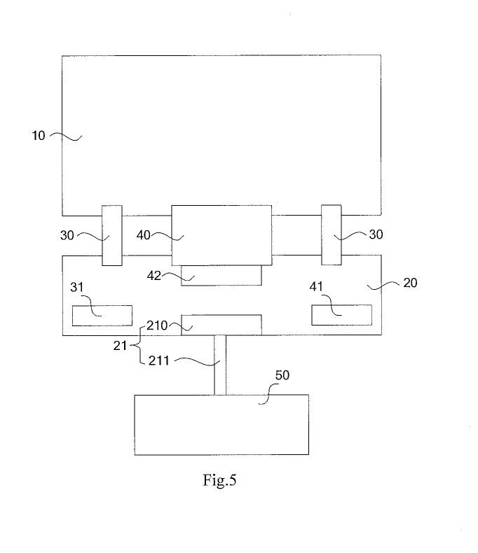

Based on the above, the touch display device may be a note book (NB), as shown in FIG. 4, the touch display device further includes a keyboard device 02. Herein, the keyboard device 02 generally includes a main frame and keystrokes which are arranged at one side of the main frame.

Further, as shown in FIG. 5, a system connector 21 is arranged at the control board 20 of the touch display panel; a system circuit board 50 for controlling the control board is provided inside the keyboard device 02 (not shown in FIG. 5); wherein the system circuit board 50 is electrically connected to the control board 20 through the system connector 21. Herein, the system connector 21 may include, for example, a connection terminal 210 and a connection line 211 leaded out from the connection terminal 210, wherein the other end 1 of the connection line 211 is connected to the system circuit panel 50, so as to control the control board 20. The system circuit panel 50 may be, for example, arranged inside the main frame of the keyboard device 02 and electrically connected to the control board 20 through the above connection line 211.

It should note that all drawings in the present disclosure are brief schematic views for the above-mentioned touch display panels, merely for clearly describing the structures related to the technical solution of the present disclosure; other structures unrelated to the technical solution of the present disclosure are existing structures in the related art, which are not shown or partially shown in the drawings.

The above are merely the specific embodiments of the present disclosure, the scope of the present disclosure is not limited hereto. It should be noted that, a person skilled in the art may further make improvements and modifications without departing from the principle of the present disclosure, and these improvements and modifications shall also be considered as the scope of the present disclosure, therefore the scope of the present disclosure shall base on the following claims.

What is claimed is:

1. A touch display panel, comprising a touch display panel body, a control board and a display circuit connection board,
wherein a display driving circuit which drives the touch display panel body to display is arranged on the control board and electrically connected to the control board;
the display circuit connection board is electrically connected to the control board and the touch display panel body, respectively,
wherein the touch display panel further comprises a touch circuit connection board, the touch circuit connection board is electrically connected to the control board and the touch display panel body,
a touch driving circuit which drives the touch display panel body to touch is arranged on the control board and electrically connected to the control board.

2. The touch display panel according to claim 1, wherein a touch circuit connector which connects the touch circuit connection board and the control board is arranged on the control board.

3. The touch display panel according to claim 1, wherein the touch display panel body comprises a touch driving electrode and a touch sensing electrode which are insulated from each other; and
the touch circuit connection board is electrically connected to the touch driving electrode and the touch sensing electrode through a touch connection line and a sensing connection line, respectively.

4. The touch display panel according to claim 1, wherein a system connector is arranged on the control board, the system connector is configured to electrically connect the control board and a system circuit connection board.

5. The touch display panel according to claim 1, wherein the control board is made by a printed circuit board.

6. The touch display panel according to claim 1, wherein the display circuit connection board is made by a flexible printed circuit board.

7. The touch display panel according to claim 1, wherein the touch circuit connection board is made by a flexible printed circuit board.

8. A touch display device, comprising the touch display panel according to claim 1.

9. The touch display panel according to claim 8, wherein a touch circuit connector which connects the touch circuit connection board and the control board is arranged on the control board.

10. The touch display panel according to claim 8, wherein the touch display panel body comprises a touch driving electrode and a touch sensing electrode which are insulated from each other; and
the touch circuit connection board is electrically connected to the touch driving electrode and the touch sensing electrode through a touch connection line and a sensing connection line, respectively.

11. The touch display panel according to claim 8, wherein a system connector is arranged on the control board, the system connector is configured to electrically connect the control board and a system circuit connection board.

12. The touch display panel according to claim 8, wherein the control board is made by a printed circuit board.

13. The touch display panel according to claim 8, wherein the display circuit connection board is made by a flexible printed circuit board.

14. The touch display panel according to claim 8, wherein the touch circuit connection board is made by a flexible printed circuit board.

15. The touch display device according to claim 8, further comprising a keyboard device.

16. The touch display device according to claim 15, wherein a system connector is arranged on the control board of the touch display panel;
a system circuit board, configure to control the control board, is arranged inside the keyboard device; and
the system circuit board is electrically connected to the control board through the system connector.
